(19) United States
(12) Patent Application Publication
(10) Pub. No.: US 2014/0081480 A1
(43) Pub. Date: Mar. 20, 2014

(54) VEHICLE CONTROL SYSTEM WITH PARAMETER SETTING FUNCTION

(71) Applicant: WISTRON CORPORATION, New Taipei City (TW)

(72) Inventor: Hsin-Chieh Wu, New Taipei City (TW)

(73) Assignee: Wistron Corporation, New Taipei City (TW)

(21) Appl. No.: 13/772,332

(22) Filed: Feb. 21, 2013

(30) Foreign Application Priority Data
Sep. 20, 2012 (TW) 101134419

(51) Int. Cl. G06F 17/00

(52) U.S. Cl. CPC G06F 17/00
USPC 701/2

(57) ABSTRACT

The present invention discloses a vehicle control system including a vehicle parameter storage device and a vehicle computer device. The vehicle storage device includes a memory module for storing vehicle parameter information, and a parameter transmission interface couple to the memory module for transmitting the vehicle parameter information. The vehicle computer device is installed inside a vehicle for controlling operation of the vehicle. The vehicle computer device includes a datum transmission interface for electrically connecting to the parameter transmission interface so as to transmit the vehicle parameter information with the parameter transmission interface, and a control module electrically connected to the datum transmission interface for controlling the operation of the vehicle according the vehicle parameter information transmitted from the datum transmission interface.

### BACKGROUND OF THE INVENTION

1. Field of the Invention

The present invention relates to a vehicle control system with parameter setting function, and more particularly, to a vehicle control system utilizing a vehicle computer device to read vehicle parameter information stored inside the vehicle storage device for functional adjustment according to personal preference.

2. Description of the Prior Art

Equipment of the high-class automobile usually has automatic adjusting function, such as the adjustable seat and driving mirror, and further has parameter memory function to record the personal habit for the automatic adjustment at the next time. However, the conventional automatic adjustment has drawbacks that the memory function is constrained to be only applied to the related automobile. The user has to reset the personal preference of the seat and the driving mirror when the habitual automobile is replaced by a new one, which wastes time and results in inconvenience

### SUMMARY OF THE INVENTION

The present invention provides a vehicle control system utilizing a vehicle computer device to read vehicle parameter information stored inside the vehicle storage device for functional adjustment according to personal preference for solving above drawbacks.

According to the claimed invention, vehicle control system includes a vehicle storage device and a vehicle computer device, the vehicle computer device is installed inside a vehicle for controlling operation of the vehicle. The vehicle storage device includes a memory module and a parameter transmission interface. The memory module is for storing vehicle parameter information. The parameter transmission interface is coupled to the memory module for transmitting the vehicle parameter information. The vehicle computer device includes a datum transmission interface and a control module. The datum transmission interface is for electrically connecting to the parameter transmission interface of the vehicle storage device, so as to transmit the vehicle parameter information with the parameter transmission interface. The control module electrically is connected to the datum transmission interface for controlling the operation of the vehicle according to the vehicle parameter information transmitted from the datum transmission interface.

The present invention utilizes the vehicle computer device to read the vehicle parameter information stored inside the vehicle storage device to automatically adjust functions of the vehicle according to the personal preference, so that the vehicle can be set as the preferably comfortable status for increasing the operation convenience.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a vehicle control system according to an embodiment of the present invention.

FIG. 2 is a functional block diagram of the vehicle control system according to the other embodiment of the present invention.

FIG. 3 is a functional block diagram of the vehicle control system according to the other embodiment of the present invention.

FIG. 4 is a functional block diagram of the vehicle control system according to the other embodiment of the present invention.

### DETAILED DESCRIPTION

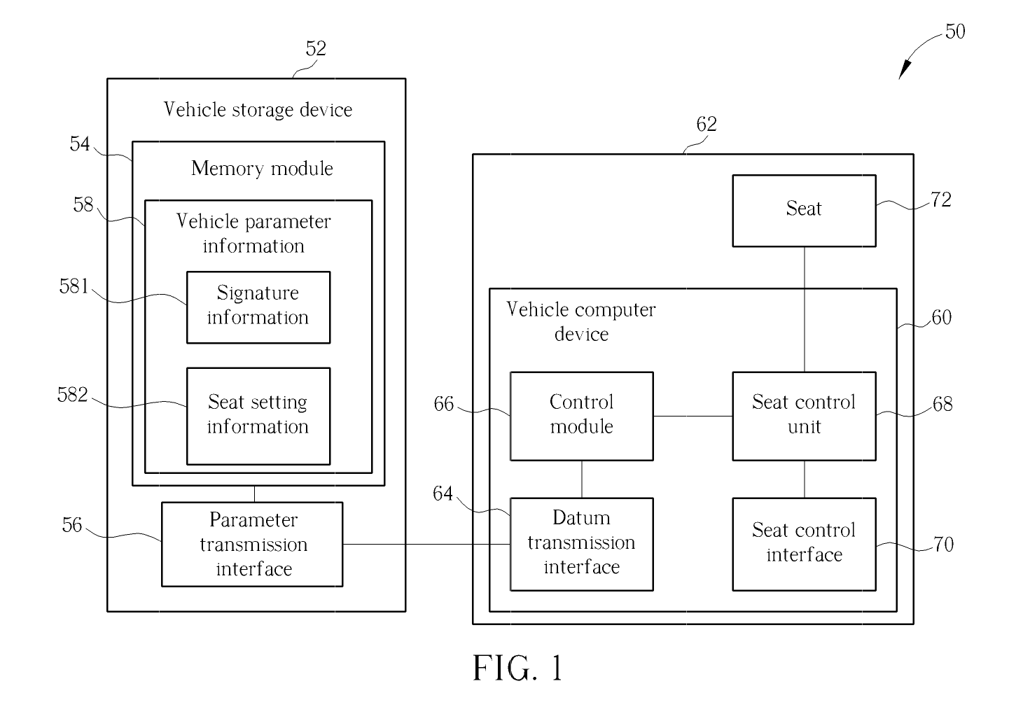

Please refer to FIG. 1. FIG. 1 is a functional block diagram of a vehicle control system 50 according to an embodiment of the present invention. The vehicle control system 50 includes a vehicle storage device 52, which can be a mobile storage device and is presented as a smart key. The vehicle storage device 52 includes a memory module 54 and a parameter transmission module 56. The memory module 54 is for storing vehicle parameter information 58. The parameter transmission interface 56 is coupled to the memory module 54 for transmitting the vehicle parameter information 58 stored inside the memory module 54. In addition, the vehicle control system 50 further includes a vehicle computer device 60 installed inside a vehicle 62 for controlling operation of the vehicle 62. The vehicle computer device 60 includes a datum transmission interface 64 for electrically connecting to the parameter transmission interface 56 of the vehicle storage device 52, so as to transmit the vehicle parameter information 58 with the parameter transmission interface 56. The parameter transmission interface 56 and the datum transmission interface 64 can respectively be universal serial bus (USB) interface or the other wire/wireless transmission interface, which depend on actual design demand. Further, the vehicle computer device 60 further includes a control module 66 electrically connected to the datum transmission interface 64. The control module 66 can control the operation of the vehicle 62 according to the vehicle parameter information 58 transmitted from the datum transmission interface 64.

Besides, the vehicle parameter information 58 can selectively include signature information 581, which corresponds to a model of the vehicle 62. The control module 66 can determine whether the operation of the vehicle 62 is controlled according to the vehicle parameter information 58 by a comparing result of the signature information 581 to predetermined signature information, so as to be security authentication. For example, the predetermined signature of vehicle model 123 of the merchant A can be set as AAA00123, the predetermined signature of vehicle model 456 of the merchant B can be set as BBB00456, and so on. When the parameter transmission module 56 of the vehicle storage device 52 is connected to the datum transmission interface 64 of the vehicle computer device 60, the control module 66 can compare the signature information 581 transmitted from the parameter transmission module 56 of the vehicle storage device 52 to the predetermined signature information of the vehicle whereon the vehicle control system 50 is installed. As the signature information 581 conforms to the predetermined signature information, the vehicle storage device 52 corresponds to the correct vehicle 62 to pass the security authentication and to continue the related setting procedure. As the signature information 581 does not conform to the predetermined signature information, the vehicle storage device 52 fails to pass the security authentication of the vehicle 62, and the related setting procedure is cancelled.

In this embodiment, the vehicle parameter information 58 can selectively include seat setting information 582. The vehicle computer device 60 can further include a seat control unit 68 and a seat control interface 70 accordingly. The seat control unit 68 is electrically connected to the control module 66, and the control module 66 can drive the seat control unit 68 to adjust a position of a seat 72 of the vehicle 62 according to the seat setting information 582 when the signature information 581 conforms to the predetermined signature information. The seat control interface 70 is electrically connected to the seat control unit 68. The seat setting information 582 is inputted via the seat control interface 70 to control the seat control unit 68. The control module 66 further can drive the datum transmission interface 64 to transmit the seat setting information 582 to the parameter transmission interface 56, so as to store the seat setting information 582 into the memory module 54. It is to say, the seat 72 can be adjusted according to user's stature and habits. When the user utilizes the seat control interface 70 to adjust the seat 72, such as adjustment of a height or inclined degrees of the seat 72, the seat control unit 68 can adjust the position of the seat 72 accordingly, and the seat setting information 582 inputted via the seat control interface 70 can be recorded as personal preference. The control module 66 can drive the datum transmission interface 64 to transmit the seat setting information 582 to the parameter transmission interface 56, so as to store the set setting information 582 into the memory module 54. Therefore, the personal preference of the seat 72 can be recorded on the parameter storage device 52.

When the vehicle 62 is utilized at the next time, the vehicle storage device 52 can be put on the correct position to connect the parameter transmission module 56 of the vehicle storage device 52 to the datum transmission interface 64 of the vehicle computer device 60, and then the control module 66 can compare whether the signature information 581 transmitted from the parameter transmission module 56 of the vehicle storage device 52 conforms to the predetermined signature information of the vehicle. As the signature information 581 conforms to the predetermined signature information, the vehicle storage device 52 corresponds to the correct vehicle 62 and the security authentication is passed. The control module 66 can read the seat setting information 582 stored inside the memory module 54 via the parameter transmission interface 56 and the datum transmission interface 64, and can drive the seat control unit 68 to adjust the seat 72 to the preference position according to the seat setting information 582. Thus, the user does not manually control the seat control interface 70 to adjust the seat 72, so the seat adjustment of the vehicle with the vehicle control system 50 of the present invention has preferred operation convenience.

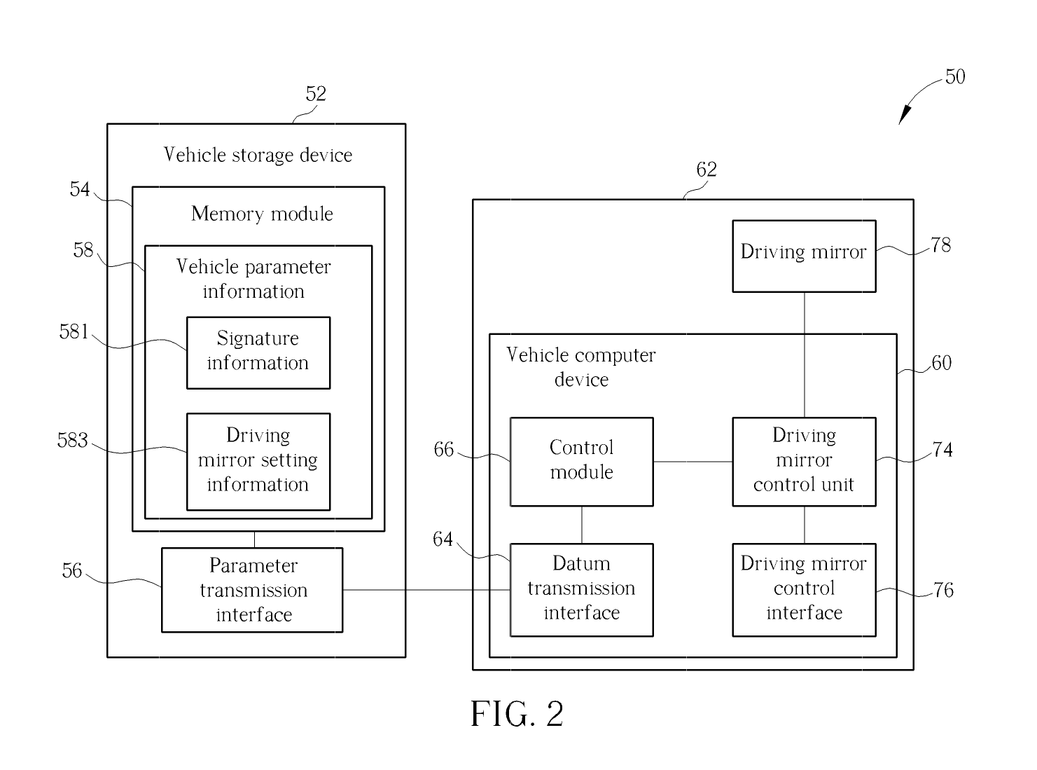

Please refer to FIG. 2. FIG. 2 is a functional block diagram of the vehicle control system 50 according to the other embodiment of the present invention. In this embodiment, the vehicle parameter information 58 can selectively include driving mirror setting information 583, and the vehicle computer device 60 can further include a driving mirror control unit 74 and a driving mirror control interface 76 accordingly. The driving mirror control unit 74 is electrically connected to the control module 66, and the control module 66 can drive the driving mirror control unit 74 to adjust a position of a driving mirror 78 of the vehicle 62 according to the driving mirror setting information 583 when the signature information 581 conforms to the predetermined signature information. The driving mirror control interface 76 is electrically connected to the driving mirror control unit 74. The driving mirror setting information 583 is inputted via the driving mirror control interface 76 to control the driving mirror control unit 74. The control module 66 further can drive the datum transmission interface 64 to transmit the driving mirror setting information 583 to the datum transmission interface 56, so as to store the driving mirror setting information 583 into the memory module 54. When the user utilizes the driving mirror control interface 76 to adjust the driving mirror 78 according to the personal preference, such as the angle adjustment of the driving mirror 78, the driving mirror control unit 74 can accordingly adjust the angle of the driving mirror 78, and the driving mirror setting information 583 inputted via the driving mirror control interface 76 can be recorded simultaneously for the personal preference. The control module 66 can drive the datum transmission interface 64 to transmit the driving mirror setting information 583 to the parameter transmission interface 56, so as to store the driving mirror setting information 583 into the memory module 54. Therefore, the personal preference of the driving mirror can be recorded on the vehicle storage device 52.

As the above-mentioned embodiment, the vehicle storage device 52 can be put on the correct position at the next utilization of the vehicle 62, so that the parameter transmission module 56 of the vehicle storage device 52 can be connected to the datum transmission interface 64 of the vehicle computer device 60. Meanwhile, the control module 66 can compare whether the signature information 581 transmitted from the parameter transmission module 56 of the vehicle storage device 52 conforms to the predetermined signature information of the vehicle. As the signature information 581 conforms to the predetermined signature information, the vehicle storage device 52 corresponds to the correct vehicle 62 and the security authentication is passed. The control module 66 can read the driving mirror setting information 583 stored inside the memory module 54 via the parameter transmission interface 56 and the datum transmission interface 64, and can drive the driving mirror control unit 74 to adjust the driving mirror 78 to the preference angle according to the driving mirror setting information 583. Thus, the user does not manually control the driving mirror control interface 76 to adjust the driving mirror 78, so the driving mirror adjustment of the vehicle with the vehicle control system 50 of the present invention has preferred operation convenience.

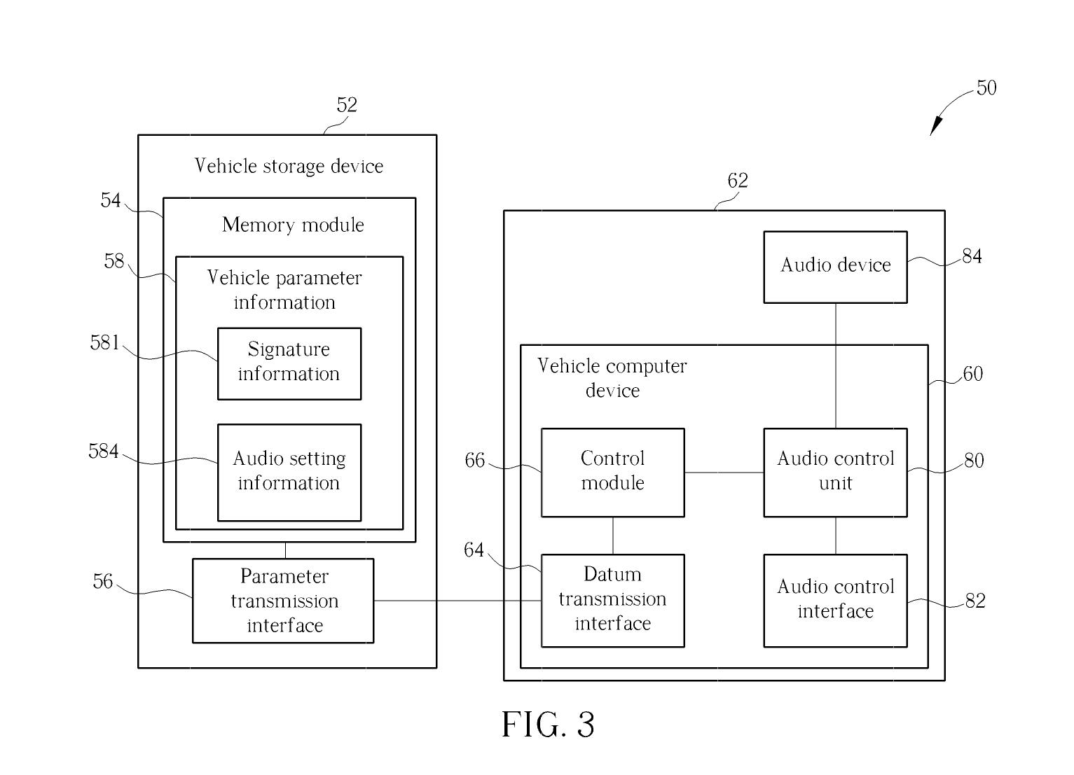

Please refer to FIG. 3. FIG. 3 is a functional block diagram of the vehicle control system 50 according to the other embodiment of the present invention. In this embodiment, the vehicle parameter information 58 can selectively include audio setting information 584, and the vehicle computer device 60 can further include an audio control unit 80 and au audio control interface 82 accordingly. The audio control unit 80 is electrically connected to the control module 66, and the control module 66 can drive the audio control unit 80 to adjust setting of an audio device 84 of the vehicle 62 according to the audio setting information 584 when the signature information 581 conforms to the predetermined signature information. The audio control interface 82 is electrically connected to the audio control unit 80. The audio setting information 584 is inputted via the audio control interface 82 to control the audio control unit 80. The control module 66 further can drive the datum transmission interface 64 to transmit the audio setting information 584 to the datum transmission interface 56, so as to store the audio setting information 584 into the memory module 54. When the user utilizes the audio control interface 82 to adjust the audio device 84 according to the personal preference, such as adjustment of the sound volume and the channel of the audio device 84, the audio control unit 80 can accordingly adjust the setting of the audio device 84, and the audio setting information 584 inputted via the audio control interface 82 can be recorded simultaneously for the personal preference. The control module 66 can drive the datum transmission interface 64 to transmit the audio setting information 584 to the parameter transmission interface 56, so as to store the audio setting information 584 into the memory module 54. Therefore, the personal preference of the audio device can be recorded on the vehicle storage device 52.

As the above-mentioned embodiment, the vehicle storage device 52 can be put on the correct position at the next utilization of the vehicle 62, so that the parameter transmission module 56 of the vehicle storage device 52 can be connected to the datum transmission interface 64 of the vehicle computer device 60. Meanwhile, the control module 66 can compare whether the signature information 581 transmitted from the parameter transmission module 56 of the vehicle storage device 52 conforms to the predetermined signature information of the vehicle. As the signature information 581 conforms to the predetermined signature information, the vehicle storage device 52 corresponds to the correct vehicle 62 and the security authentication is passed. The control module 66 can read the audio setting information 584 stored inside the memory module 54 via the parameter transmission interface 56 and the datum transmission interface 64, and can drive the audio control unit 80 to adjust the audio device 84 to the preference setting according to the audio setting information 584. Thus, the user does not manually control the audio control interface 82 to adjust the audio device 84, so the audio adjustment of the vehicle with the vehicle control system 50 of the present invention has preferred operation convenience.

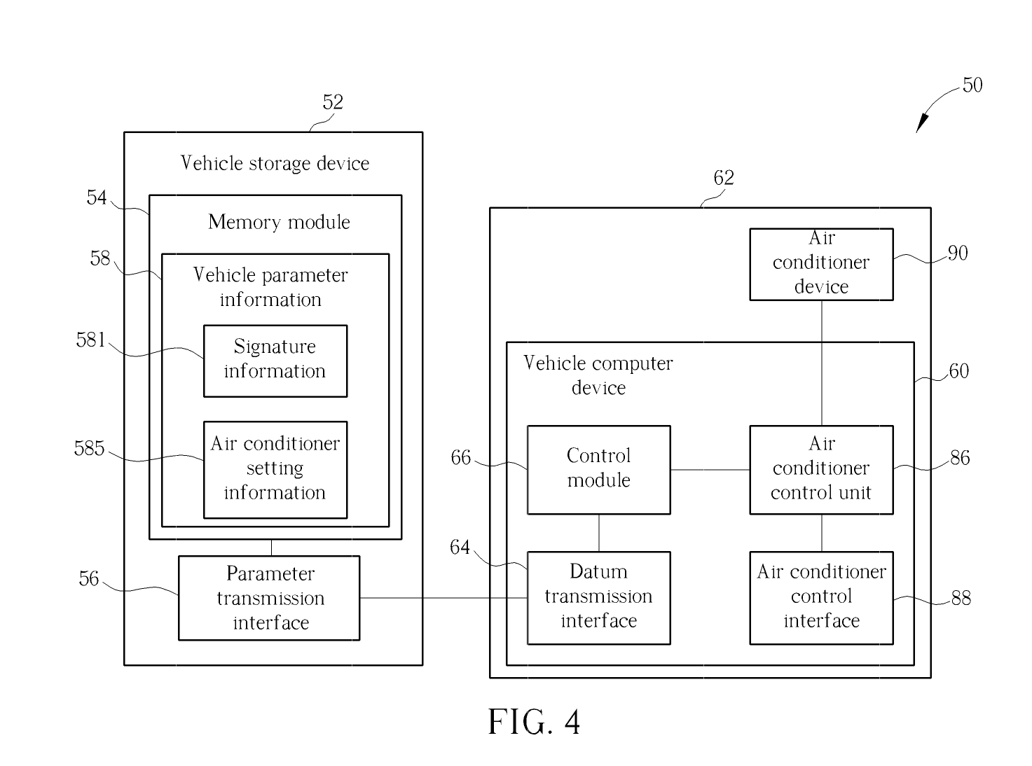

Please refer to FIG. 4. FIG. 4 is a functional block diagram of the vehicle control system 50 according to the other embodiment of the present invention. In this embodiment, the vehicle parameter information 58 can selectively include air conditioner setting information 585, and the vehicle computer device 60 can further include an air conditioner control unit 86 and au air conditioner control interface 88 accordingly. The air conditioner control unit 86 is electrically connected to the control module 66, and the control module 66 can drive the air conditioner control unit 86 to adjust setting of an air conditioner device 90 of the vehicle 62 according to the air conditioner setting information 585 when the signature information 581 conforms to the predetermined signature information. The air conditioner control interface 88 is electrically connected to the air conditioner control unit 86. The air conditioner setting information 585 is inputted via the air conditioner control interface 88 to control the air conditioner control unit 86. The control module 66 further can drive the datum transmission interface 64 to transmit the air conditioner setting information 585 to the datum transmission interface 56, so as to store the air conditioner setting information 585 into the memory module 54. When the user utilizes the air conditioner control interface 88 to adjust the air conditioner device 90 according to the personal preference, such as adjustment of the air volume and the temperature of the air conditioner device 90, the air conditioner control unit 86 can accordingly adjust the setting of the air conditioner device 90, and the air conditioner setting information 585 inputted via the air conditioner control interface 88 can be recorded simultaneously for the personal preference. The control module 66 can drive the datum transmission interface 64 to transmit the air conditioner setting information 585 to the parameter transmission interface 56, so as to store the air conditioner setting information 585 into the memory module 54. Therefore, the personal preference of the air conditioner device can be recorded on the vehicle storage device 52.

As the above-mentioned embodiment, the vehicle storage device 52 can be put on the correct position at the next utilization of the vehicle 62, so that the parameter transmission module 56 of the vehicle storage device 52 can be connected to the datum transmission interface 64 of the vehicle computer device 60. Meanwhile, the control module 66 can compare whether the signature information 581 transmitted from the parameter transmission module 56 of the vehicle storage device 52 conforms to the predetermined signature information of the vehicle. As the signature information 581 conforms to the predetermined signature information, the vehicle storage device 52 corresponds to the correct vehicle 62 and the security authentication is passed. The control module 66 can read the air conditioner setting information 585 stored inside the memory module 54 via the parameter transmission interface 56 and the datum transmission interface 64, and can drive the air conditioner control unit 86 to adjust the air conditioner device 90 to the preference setting according to the air conditioner setting information 585. Thus, the user does not manually control the air conditioner control interface 88 to adjust the air conditioner device 90, so the air conditioner adjustment of the vehicle with the vehicle control system 50 of the present invention has preferred operation convenience.

In conclusion, the present invention can utilize the vehicle computer device 60 to read the vehicle parameter information 58 stored inside the vehicle storage device 52 to adjust functions of the vehicle according to the personal preference. It is to say, each user can own the exclusive vehicle storage device 52. The vehicle storage device 52 is put on the correct position of the vehicle 62 to upload the vehicle parameter information 58 (the personal preference) toward the vehicle computer device 60, and the vehicle computer device 60 can adjust functions of the vehicle 62 according to the downloaded personal preference. In addition, the vehicle parameter information 58 of the present invention can selectively integrate the above-mentioned setting information, such as the seat setting information 582, the driving mirror setting information 583, the audio setting information 584 and the air conditioner setting information 585, so that the seat 72, the driving mirror 78, the audio device 84 and the air conditioner device 90 can be adjusted according to the above-mentioned information for the proper personal preference. Therefore, system capable of utilize the vehicle computer device 60 to read the vehicle parameter information 58 stored inside the vehicle storage device 52 for automatic adjustment of the personal preference functions of the vehicle belongs to scopes of the present invention, setting information of the vehicle parameter information is not limited to the above-mentioned embodiments, and depends on actual design demand.

Comparing to the prior art, the present invention utilizes the vehicle computer device to read the vehicle parameter information stored inside the vehicle storage device to automatically adjust functions of the vehicle according to the personal preference, so that the vehicle can be set as the preferably comfortable status for increasing the operation convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A vehicle control system with parameter setting function, the vehicle control system comprising:
a vehicle storage device, the vehicle storage device comprising:
a memory module for storing vehicle parameter information; and
a parameter transmission interface coupled to the memory module for transmitting the vehicle parameter information stored inside the memory module; and
a vehicle computer device installed inside a vehicle for controlling operation of the vehicle, the vehicle computer device comprising:
a datum transmission interface for electrically connecting to the parameter transmission interface of the vehicle storage device, so as to transmit the vehicle parameter information with the parameter transmission interface; and
a control module electrically connected to the datum transmission interface for controlling the operation of the vehicle according to the vehicle parameter information transmitted from the datum transmission interface.

2. The vehicle control system of claim 1, wherein the vehicle parameter information comprises signature information corresponding to model information of the vehicle, and the control module determines whether the operation of the vehicle is controlled according to the vehicle parameter information by a comparing result of the signature information to predetermined signature information.

3. The vehicle control system of claim 2, wherein the vehicle parameter information further comprises seat setting information, the vehicle computer device further comprises a seat control unit electrically connected to the control module, and the control module drives the seat control unit to adjust a position of a seat of the vehicle according to the seat setting information when the signature information conforms to the predetermined signature information.

4. The vehicle control system of claim 3, wherein the vehicle computer device further comprises a seat control interface electrically connected to the seat control unit, the seat setting information is inputted via the seat control interface to control the seat control unit, and the control module further drives the datum transmission interface to transmit the seat setting information to the parameter transmission interface, so as to store the seat setting information into the memory module.

5. The vehicle control system of claim 2, wherein the vehicle parameter information further comprises driving mirror setting information, the vehicle computer device further comprises a driving mirror control unit electrically connected to the control module, and the control module drives the driving mirror control unit to adjust an angle of a driving mirror of the vehicle according to the driving mirror setting information when the signature information conforms to the predetermined signature information.

6. The vehicle control system of claim 5, wherein the vehicle computer device further comprises a driving mirror control interface electrically connected to the driving mirror control unit, the driving mirror setting information in inputted via the driving mirror control interface to control the driving mirror control unit, and the control module further drives the datum transmission interface to transmit the driving mirror setting information to the parameter transmission interface, so as to store the driving mirror setting information into the memory module.

7. The vehicle control system of claim 2, wherein the vehicle parameter information further comprises audio setting information, the vehicle computer device further comprises an audio control unit electrically connected to the control module, and the control module drives the audio control unit to adjust setting of an audio device of the vehicle according to the audio setting information when the signature information conforms to the predetermined signature information.

8. The vehicle control system of claim 7, wherein the vehicle computer device further comprises an audio control interface electrically connected to the audio control unit, the audio setting information is inputted via the audio control interface to control the audio control unit, and the control module further drives the datum transmission interface to transmit the audio setting information to the parameter transmission interface, so as to store the audio setting information into the memory module.

9. The vehicle control system of claim 2, wherein the vehicle parameter information further comprises air conditioner setting information, the vehicle computer device further comprises an air conditioner control unit electrically connected to the control module, and the control module drives the air conditioner control unit to adjust setting of an air conditioner device of the vehicle according to the air conditioner setting information when the signature information conforms to the predetermined signature information.

10. The vehicle control system of claim 9, wherein the vehicle computer device further comprises an air conditioner control interface electrically connected to the air conditioner control unit, the air conditioner setting information is inputted via the air conditioner control interface to control the air conditioner control unit, and the control module further drives the datum transmission interface to transmit the air conditioner setting information to the parameter transmission interface, so as to store the air conditioner setting information into the memory module.

11. The vehicle control system of claim 1, wherein the vehicle parameter information further comprises seat setting information, the vehicle computer device further comprises a seat control unit electrically connected to the control module, and the control module drives the seat control unit to adjust a position of a seat of the vehicle according to the seat setting information.

12. The vehicle control system of claim 11, wherein the vehicle computer device further comprises a seat control interface electrically connected to the seat control unit, the seat setting information is inputted via the seat control interface to control the seat control unit, and the control module further drives the datum transmission interface to transmit the seat setting information to the parameter transmission interface, so as to store the seat setting information into the memory module.

13. The vehicle control system of claim 1, wherein the vehicle parameter information further comprises driving mirror setting information, the vehicle computer device further comprises a driving mirror control unit electrically connected to the control module, and the control module drives the driving mirror control unit to adjust an angle of a driving mirror of the vehicle according to the driving mirror setting information.

14. The vehicle control system of claim 13, wherein the vehicle computer device further comprises a driving mirror control interface electrically connected to the driving mirror control unit, the driving mirror setting information is inputted via the driving mirror control interface to control the driving mirror control unit, and the control module further drives the datum transmission interface to transmit the driving mirror setting information to the parameter transmission interface, so as to store the driving mirror setting information into the memory module.

15. The vehicle control system of claim 1, wherein the vehicle parameter information further comprises audio setting information, the vehicle computer device further comprises an audio control unit electrically connected to the control module, and the control module drives the audio control unit to adjust setting of an audio device of the vehicle according to the audio setting information.

16. The vehicle control system of claim 15, wherein the vehicle computer device further comprises an audio control interface electrically connected to the audio control unit, the audio setting information is inputted via the audio control interface to control the audio control unit, and the control module further drives the datum transmission interface to transmit the audio setting information to the parameter transmission interface, so as to store the audio setting information into the memory module.

17. The vehicle control system of claim 1, wherein the vehicle parameter information further comprises air conditioner setting information, the vehicle computer device further comprises an air conditioner control unit electrically connected to the control module, and the control module drives the air conditioner control unit to adjust setting of an air conditioner device of the vehicle according to the air conditioner setting information.

18. The vehicle control system of claim 17, wherein the vehicle computer device further comprises an air conditioner control interface electrically connected to the air conditioner control unit, the air conditioner setting information is inputted via the air conditioner control interface to control the air conditioner control unit, and the control module further drives the datum transmission interface to transmit the air conditioner setting information to the parameter transmission interface, so as to store the air conditioner setting information into the memory module.

19. The vehicle control system of claim 1, wherein the parameter transmission interface and the datum transmission interface respectively are universal serial bus.
